(19) United States
(12) Patent Application Publication
(10) Pub. No.: US 2012/0112449 A1
(43) Pub. Date: May 10, 2012

(54) Systems and Methods for Production of Customized Publications

(76) Inventors: David Engel, Toronto (CA); Tina Engel Erlich, Toronto (CA)

(21) Appl. No.: 13/291,881

(22) Filed: Nov. 8, 2011

Related U.S. Application Data
(60) Provisional application No. 61/411,119, filed on Nov. 8, 2010.

(51) Int. Cl. B42D 1/00; B41F 33/00

(52) U.S. Cl. 281/15.1; 101/483

(57) ABSTRACT

Systems and methods for manufacturing a customized publication are provided. The method may comprise printing a first set of customized components for each publication. The first set may include a component customized to a recipient. The method may further provide for printing a second set of customized components for each publication. The second set may include a component that is customized to the recipient. The method may even further provide for associating the component from the first set with the component from the second set to form a customized publication section for the recipient. In various embodiments, the method may further comprise providing the customized publication section for associating with an uncustomized section. Accessing a database storing recipient data, wherein the recipient data is used to print the customized components from the first and second sets for the recipient may also be provided.

### CROSS-REFERENCE TO RELATED APPLICATIONS

The present application claims priority to co-pending U.S. Provisional Application No. 61/411,119, filed Nov. 8, 2010, entitled “Production of Customized Magazines,” which is hereby incorporated herein by reference in its entirety.

### FIELD OF THE INVENTION

The present disclosure generally relates to production of publications, and more particularly, to systems and methods for the production of customized publications to recipients.

### BACKGROUND

Presently available printed content or publications (e.g., magazines, pamphlets, booklets, etc.) may include a cover that unfolds to provide additional images or information. In some instances, labels personalized to a recipient may also be appended to an otherwise generic magazine. Personalizing or customizing large amounts of content may be difficult and inefficient, since each customized component must be matched to a correspondingly customized component. For example, a magazine with multiple customized components requires either piecemeal production (e.g., one customized magazine at a time) or an arduous matching process following bulk printing of the magazine components. In addition, current personalization may be limited. For example, publications may have an ink jet line of type or copy with an individual's name or personalized number in the copy of an advertisement. Such a personalization may be limited to a space only 1″ tall.

An example of a presently existing method may include generating a plurality of barcodes for a set of magazines to be manufactured. Each barcode may uniquely designate a magazine in the set. A first set and a second set of customized components may be printed for each magazine. A component from the first set may be customized to a particular recipient of the magazine and be associated with one of the plurality of barcodes. Likewise, a component from the second set of components may be customized to that particular recipient and be associated with a corresponding barcode. During assembly, the component from the first set are automatically matched together (e.g., using a camera or barcode scanner) with a component in the second set based on corresponding barcodes before being bound together in any fashion known in the art (e.g., saddle stitch, perfect bound). Variations allow for any number of customized components; each component for a particular magazine can simply be associated (e.g., appended, printed) with a barcode. As such, whole magazines comprising multiple components customized to particular recipients can be produced in bulk without mismatching recipient information. Such systems requiring such matching are, however, of limited or single line personalization, highly inefficient, and oftentimes produce inconsistent results (e.g., mismatching customized components). As such, there is a need for improved systems and methods for producing customized printed content or publications.

### SUMMARY OF THE INVENTION

According to various embodiments, a method for manufacturing a customized publication. The method may comprise printing a first set of customized components for each publication. The first set may include a component customized to a recipient. The method may further provide for printing a second set of customized components for each publication. The second set may include a component that is customized to the recipient. The method may even further provide for associating the component from the first set with the component from the second set to form a customized publication section for the recipient. In various embodiments, the method may further comprise providing the customized publication section for associating with an uncustomized section. Accessing a database storing recipient data, wherein the recipient data is used to print the customized components from the first and second sets for the recipient may also be provided. In certain embodiments, the method may further include accessing a database storing one or more of recipient data, photographs, images, and textual content. The recipient data, photographs, images, and textual content may be used to print the customized components from the first and second sets for the recipient. Various embodiments may also provide for accessing a plurality of databases storing recipient data used to print the customized components for the recipient. In such embodiments, at least two of the plurality of databases may be provided by different providers. In some embodiments, the first set of customized components are printed on a different paper stock than the second set of customized components. The different paper stocks may differ from each other based upon one or more of weight, color, texture, thickness, finishing, composition, and dimensions. Further aspects may provide for the components being associated using one or more of glue, staples, stitching, sewing, tape, metal, and resin. The method may be utilized to produce a publication that is a magazine, a booklet, a catalog, or a newsletter.

In even further embodiments, a method is provided for manufacturing a customized publication. The method may comprise printing a plurality of components for a set of publications. The plurality of components may include cover components, one or more insert sheets, and customized components. The one or more insert sheets and customized components may be customized to a recipient. The method may further comprise associating two of the cover components together, the two associated cover components defining an opening. The method may even provide for inserting one or more of the insert sheets into the opening and associating the two cover components with the customized components to form a customized publication. Various aspects may provide the cover components and customized components associated using one or more of glue, staples, stitching, sewing, tape, metal, and resin. In certain embodiments, the cover components may be customized to the recipient. The method may even further provide for selecting cover components and customized insert sheets having different physical properties. The physical properties may include one or more of a style, a weight, a color, a texture, a thickness, a finish, a pattern, a composition, and dimensions. Further, associating the two cover components further may define a pocket, the pocket acts as a front cover or a back cover of the customized publication. The method may comprise providing the customized publication section for associating with an uncustomized section. In certain embodiments, accessing one or more databases storing recipient data for a plurality of recipients, wherein the recipient data is used to print the one or more insert sheets and the customized components for the recipient, may also be provided. The method may further provide for a publication that is a magazine, a booklet, a catalog, or a newsletter.

And even further aspects may provide for a method of manufacturing a customized publication. The method may comprise accessing one or more databases storing one or more of recipient data, photographs, images, and textual content for a plurality of recipients; printing a first set and a second set of customized components based on the stored recipient data, the recipient data being used to customize the components to each recipient; and forming at least a portion of a customized publication using the first and second set of customized components. The method may further comprise providing the customized publication for binding to an uncustomized section. The first set of customized components may be printed on a different paper stock than the second set of customized components.

### BRIEF DESCRIPTION OF THE DRAWINGS

FIG. 1 is a flow diagram showing an exemplary method of manufacturing a customized publication;

FIG. 2 is an end view showing an exemplary customized publication constructed in accordance with the present disclosure;

FIG. 3 is a perspective view showing the exemplary customized publication shown in FIG. 2;

FIG. 4 is a block diagram showing an exemplary printing press used to construct at least a portion of a customized publication in accordance with the present disclosure;

FIG. 5 is a flow diagram showing another exemplary method of manufacturing a customized publication;

FIG. 6 is a perspective view of another customized publication constructed in accordance with the present disclosure;

FIG. 7 is a flow diagram showing yet another exemplary method of manufacturing a customized publication; and

FIG. 8 is a side view of a customized publication showing the pocket feature in greater detail.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

It is to be understood that the term “publication” or “publications” as used herein generally refers to any printed matter. Exemplary publications include, but are not limited to, collections of printed content, pamphlets, booklets, books, newspapers, catalogs, magazines, mailings, newsletters, trade publications, etc. The publications may be an international publication, a national publication, a regional publication, a local publication, etc.

Embodiments of the present disclosure generally provide systems and methods for producing publications that are customized for each recipient. For example, the present disclosure provides for the efficient, reliable, accurate, and economically feasible system for mass printing of publications wherein at least a portion of each of the publications are customized for each of the intended recipients. The customized publications (or portions thereof) may be printed and provided for combining with uncustomized components to thereby form the publication.

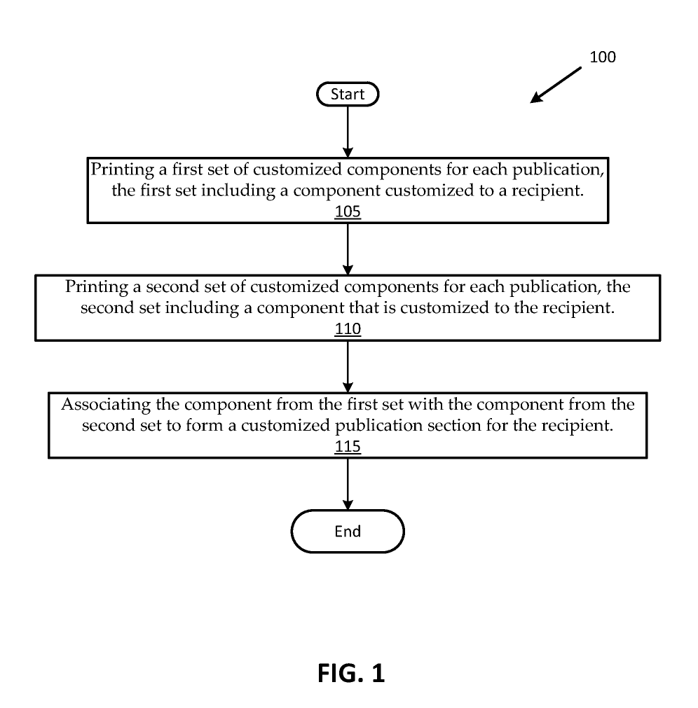

Referring now to FIG. 1, shown therein is a flow diagram of an exemplary method 100 for manufacturing a customized publication in accordance with the present disclosure. The method 100 may include a step 105 of printing a first set of customized components for each publication, the first set including a component customized to a recipient. In some embodiments, at least one of the components may comprise a cover. Exemplary information that may be customized for each of the recipients may include images, textual content, data personalized to each of the recipients, etc. The printing of the first set may be done on an automated printing press. Embodiments of the present invention enable customizations that are larger and higher quality than before.

The method 100 may further include a step 110 of printing a second set of customized components for each publication, the second set including a component that is customized to the recipient. The printing of the second set may be done using an automated printing press. The printing of the second set may be done concurrently with the printing of the first set. The recipient may be an individual, a business, a government entity, an organization, etc. Generally, the first and second sets of customized components includes information, data, images, etc., that are customized to the recipient such that the publication can be more personal and relevant to the recipient. Generally, the first and second set of customized components may be one or more pieces of rectangular paper or printable material.

The method 100 may even further include a step 115 of associating the component from the first set with the component from the second set to form a customized publication section for the recipient. The component from the first and second sets may be associated automatically using, for example, a printing press. Various aspects may provide for the customized publication section to be associated together and then organized by, for example, the zip codes for the intended recipients or the surnames of the intended recipients (alphabetically). In some embodiments, the components may associated or otherwise bound together using one or more of glue, staples, stitching, sewing, tape, metal, and resin. The components may be associated, for example, using hardcover binding (such as case binding, oversewing, sewing through the fold, and double-fan adhesive binding), punch and bind (such as wire binding, comb binding, strip binding, and spiral binding), thermally activated binding, stitched or sewn binding, and the like.

In some embodiments, the customized publication section may constitute the customized publication. In this case, the customized publication may then be distributed or otherwise provided to the recipients. In other embodiments, the customized publication section may be associated with an uncustomized section to thereby form the customized publication. The customized publication section may be associated with the uncustomized section automatically or the customized publication section may be provided to a second entity (e.g., an end-user publisher/printing press). In this case, the second entity can associate the uncustomized section with the customized publication section. The customized publication section may be organized by, for example, zip codes, before being provided to the second entity so as to permit the second entity to associate the uncustomized section with the customized publication section and then distribute the customized publication to the correct recipient.

For example, a first set of pages (e.g., the first set of customized components) may be printed, including a page 1 that is customized to Recipient A. A second set of pages (e.g., the second set of customized components) may also be printed, including a page 2 customized to Recipient A. There may be additional pages or sections as well. The pages (e.g., 1 and 2) that are customized to Recipient A may be associated or otherwise bound together to form a customized publication section in which each page has been customized to Recipient A. The customized publication section may further be associated or bound to uncustomized section(s) to form a publication that has customized and uncustomized pages/sections.

Various aspects may provide for the first set of customized components to be printed on a different paper stock than the second set of customized components. The different paper stocks may differ from each other based upon one or more of weight, color, texture, thickness, finishing, composition, and dimensions. The different paper stocks may also differ from each other based upon one or more of gloss coating, matte coating, uncoated offset, lightweight, heavyweight, etc. In a preferred embodiment, the second set of customized components may be die-cut so as to be smaller than the first set of customized components.

In some embodiments, the method 100 may further include accessing (not shown in FIG. 1) a database storing recipient data, wherein the recipient data is used to print the customized components from the first and second sets for the recipient. Exemplary information/data stored on the database includes, but is not limited to, recipient data, photographs, images, and textual content. The recipient data, photographs, images, and textual content may include data or information that is personalized for each of the intended recipients. For example, the recipient data may include information related to the recipient's likes/dislikes, hobbies, occupation, family status, purchasing history, age, geographic location, etc. The recipient data, photographs, images, and textual content may be used to print the customized components from the first and second sets for the recipient. More particularly, various aspects may provide for accessing the database storing the recipient data as the first and second sets of customized components are being printed. As such, the recipient data may be utilized or included so as to customize the first and second sets of customized components to each of the intended recipients.

For example, imaging capabilities may provide for variable imaging within the publication that can change with respect to a particular intended recipient of the publication. A recipient may designate certain preferences for cover art (e.g., favorite celebrities, article topics of interest, etc.) The publication that is customized for such a recipient may feature a cover in which the headlines and photography correspond as much as possible to the recipient's expressed interests and preferences. In some embodiments, a customized cover may be customized using a one-color, two-color, three-color, and/or four-color process individually or in different permutations.

The present disclosure may further include aspects wherein the customized components or sections include advertisements targeted to the intended recipient. For example, an advertiser may customize the publication based on the recipient's purchasing history or identified purchasing desires. Such targeted advertisements may further be customized based on the geographic location of the recipient. Further exemplary customized components or content that may be included in a publication include: an order form, application, coupon, voucher, envelope, or other promotional material having the recipient's personal information pre-printed thereon.

In some embodiments, the method 100 may include accessing (not shown in FIG. 1) a plurality of databases storing the recipient data used to print the customized components for the recipient. Various aspects may provide for at least two of the plurality of databases to be provided by different providers or sources (e.g., different publishers or advertisers). For example, the method 100 may be implemented by a first entity having a first database including at least some recipient information. However, the first entity carrying out the method 100 may further access a second database having additional recipient data wherein the recipient data from the first and second entity's databases are used to print the first and second sets of customized components. Said aspects permit a second entity to maintain the secrecy or otherwise control access to the recipient data stored on their database (e.g., proprietary data).

Generally, printing the first and second sets of customized components may be accomplished using, for example, a printing press (discussed in more detail below). The printing press may include a computerized system or processing system including the database storing the recipient data. In other aspects, the printing press may be in communication with a separate computerized system or processing system including the database storing the recipient data.

It is to be understood that accessing the database or the plurality of databases may be accomplished via a module (or software application) operating on the printing press or on a separate processing system in communication with the printing press. A module (or software application) should be generally understood as a collection of routines that perform various system-level functions and may be dynamically loaded and unloaded by hardware and device drivers as required. The modular software components described herein may also be incorporated as part of a larger software platform or integrated as part of an application specific component.

Some of the above-described functions can be composed of instructions that are stored on storage media (e.g., computer-readable medium). The instructions may be retrieved and executed by a processor. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media. It is noteworthy that any hardware platform suitable for performing the processing described herein is suitable for use with the invention. The terms “computer readable medium” and “computer-readable media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, an EEPROM, a FLASHEPROM, any other memory chip, memory module, or cartridge, a carrier wave, or any other medium from which a computer can read. Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

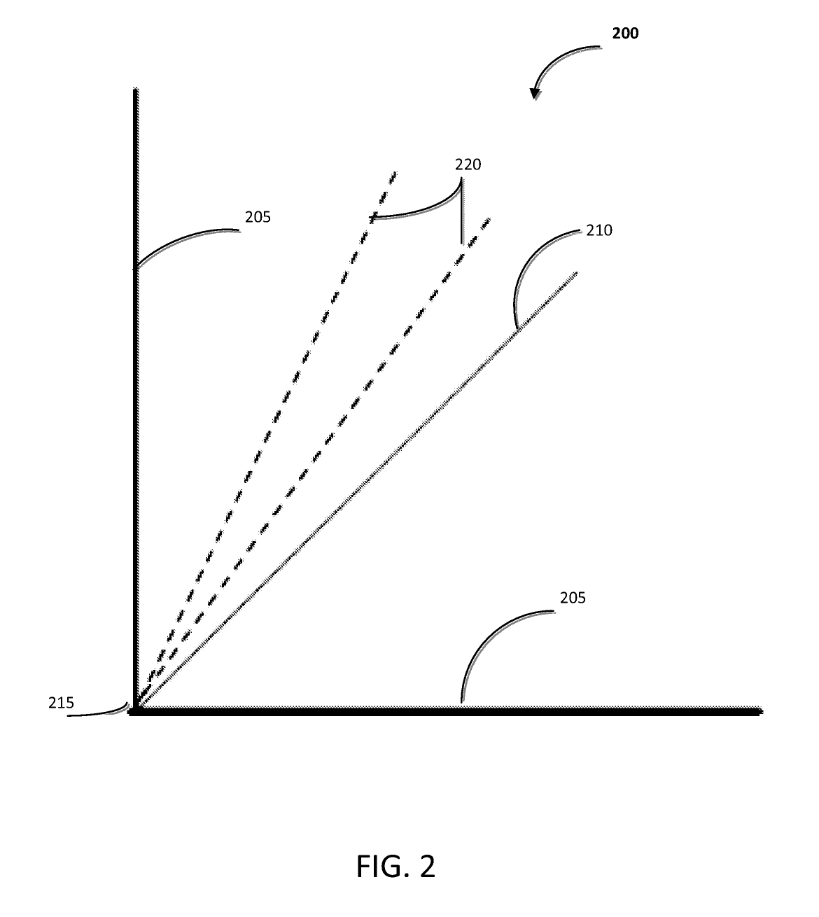

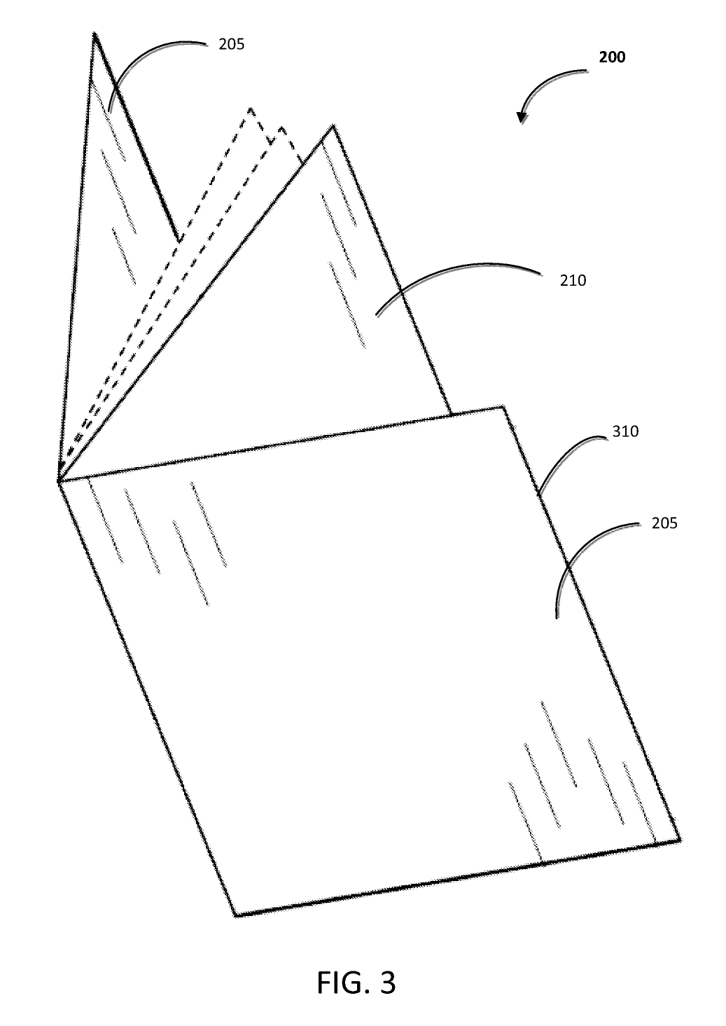

Turning now to FIG. 2, shown therein is an end view of an exemplary publication 200 manufactured using the method 100. The publication 200 comprises a first set of customized components 205 and a second set of customized components 210. The first and second sets 205 and 210, respectively, are associated together at 215 to thereby form a customized publication section. As discussed above, the first and second sets 205 and 210 may be associated together using one or more of glue, staples, stitching, sewing, tape, metal, and resin. The publication 200 may further include an uncustomized section 220 (two being shown in FIG. 2) that are associated with the first and second sets 205 and 210 to thereby form a customized publication 200. The publication 200 may be a magazine, a booklet, a catalog, a newsletter, etc. FIG. 3 shows a perspective view of the exemplary publication 200 shown in FIG. 2.

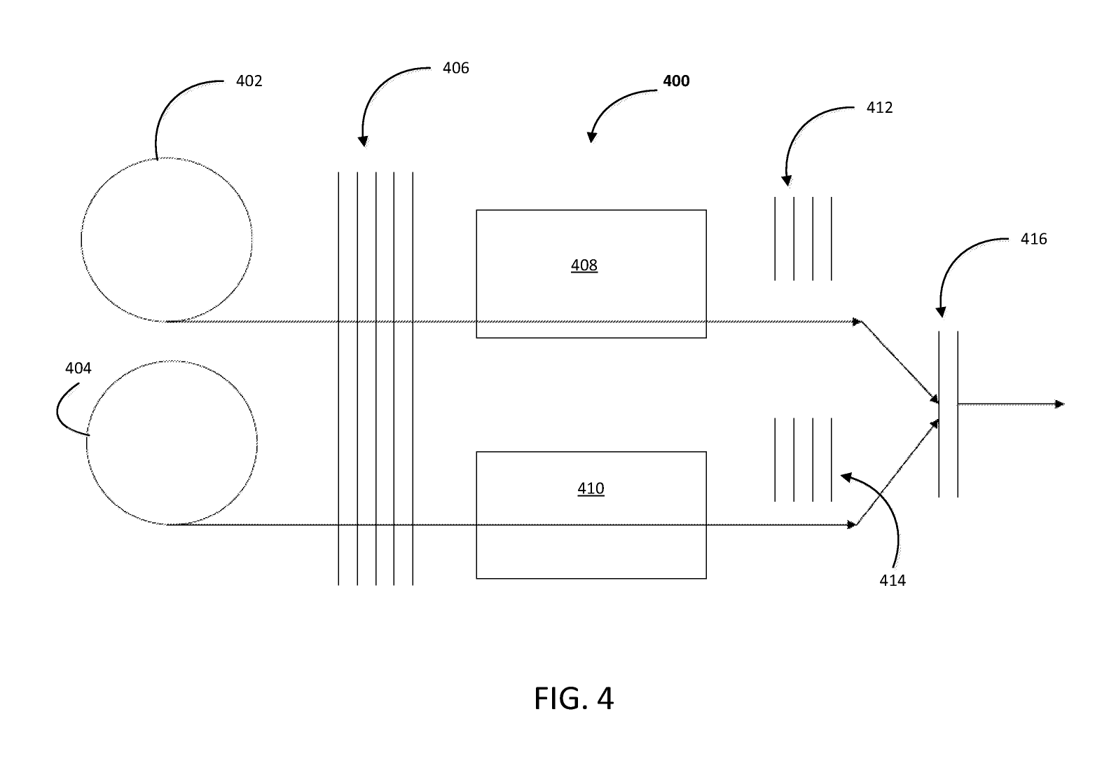

FIG. 4 shows a block diagram of an exemplary printing press 400 configured to manufacture the customized publication, in accordance with the present disclosure. The press 400 comprises a first roll of paper 402, a second roll of paper 404, a first printing stack 406, a first imaging portion 408, a second imaging portion 410, a first drying portion 412, a second drying portion 414, and a finishing portion 416. The finishing portion 416 may also be known as a bindery line. Generally, the press 400 is configured to print the first and second sets of customized components forming the customized publication.

In operation, the first and second rolls (or webs) of paper 402 and 404, respectively, are run through the first printing stack 406. The printing stack 406 applies the ink to the first and second rolls of paper 402 and 404. The printing stack 406 may include a plurality of stacks of ink (five being shown in FIG. 4), wherein each stack represents one of the CMYK colors followed by a black ink. The first and second rolls of paper 402 and 404 then proceeds into the first and second imaging portions 408 and 410, respectively. The first and second imaging portions 408 and 410 generally personalize or customize the first and second rolls of paper 402 and 404. The first and second imaging portions 408 and 410 may customize the first and second rolls of paper 402 and 404 with, for example, information whether it be just a name and address of the recipient or a completely variable set of images. The first and second imaging portions 408 and 410 may access the databases, or the plurality of databases discussed above, so as to retrieve the recipient data used to customize the sections of the publication. The first and second rolls of paper 402 and 404 may then proceed through the first and second drying portions 412 and 414, respectively. The first and second drying portions 412 and 414 may dry the images, text, etc, printed on the first and second rolls of paper 402 and 4040 so as to ensure that nothing ruins (e.g., smudges) the ink once it reaches the finishing portion of the press. The first and second rolls of paper 402 and 404 may then be joined together so as to proceed through the finishing portion 416 of the press 400. The finishing portion 416 may be configured to, for example, fold, die cut, bind, sort, etc., to create the customized publication. For example, the customization(s) may appear on one or more pages and the components coupled on the bindery line. As discussed above, the first and second rolls of paper 402 and 404 may be different paper stock.

Other permutations and combinations of printing press 400 may be used. In further embodiments, one or more of the first roll of paper 402, the second roll of paper 404, the first printing stack 406, the first imaging portion 408, a second imaging portion 410, a first drying portion 412, a second drying portion 414, and a finishing portion 416, may be omitted and/or positioned in one or more separate pieces of equipment (not shown), and the operations may be performed in two or more different stages. The separate pieces of equipment may be coupled and/or in-line to each other and to the printing press 400. For example, a first roll of paper 402 and the second roll of paper 404 printed in a printing press 400 may then be provided to a separate (in-line) finishing portion 416 (also known as a bindery line). As another example, the finishing and personalization may be performed in two different stages. The separation of finishing and personalization stages may offer greater flexibility in the selection of paper stocks which may be used (e.g., different sizes).

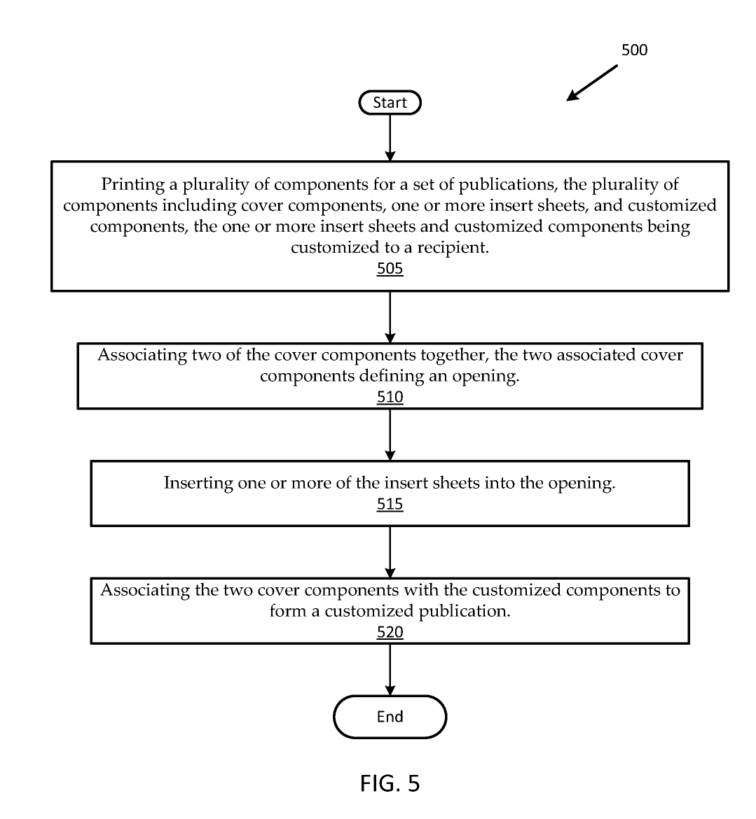

FIG. 5 shows a flow diagram of another exemplary method 500 for manufacturing a customized publication, in accordance with the present disclosure. The method 500 may be employed so as to manufacture publications wherein each of the publications is customized to an intended recipient. The method 500 may include a step 505 of printing a plurality of components for a set of publications, the plurality of components including cover components, one or more insert sheets, and customized components, the one or more insert sheets and customized components being customized to a recipient. The cover components and the customized insert sheets may have different physical properties. The differing physical properties may include one or more of a style, a weight, a color, a texture, a thickness, a finish, a pattern, a composition, or dimensions. The cover components may be customized to the recipient.

The method 500 may further include a step 510 of associating two of the cover components together, the two associated cover components defining an opening (see the opening 310 shown in FIG. 3, the opening 310 being defined between the first set of customized components 205, e.g., the two associated cover components). The opening 310 may be formed between the two cover components 205 such that, when the two or more cover components are closed or sandwiched together (e.g., selective coupling with adhesive, staples, and the like), the opening 310 is configured to, for example, receive and store additional printed content to be distributed to the recipient. The method 500 may include a step 515 of inserting one or more of the insert sheets into the opening.

The method 500 may further include a step 520 of associating the two cover components with the customized components to form a customized publication. As discussed above, the cover components and customized components may be associated using one or more of glue, staples, stitching, sewing, tape, metal, or resin.

Similar to the method 100 discussed above, the method 500 may further include accessing a database, or a plurality of databases storing recipient data. The recipient data may include information particular to each of the intended recipients. Accessing the database(s) permits each of the sections or components to be customized for the recipient based on, for example, the recipient's age, marital status, purchasing history, hobbies, likes and dislikes, geographical location, etc. The customized publication manufactured using the method 500 may be a magazine, a booklet, a book, a catalog, a newsletter, etc.

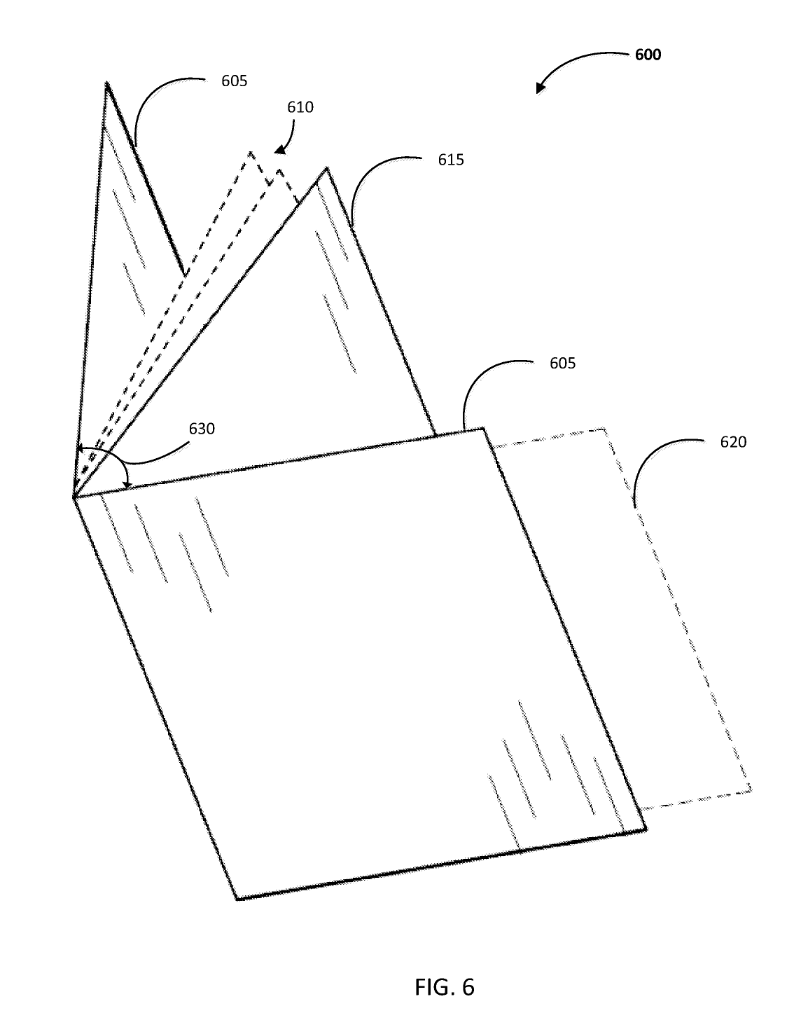

FIG. 6 shows a perspective view of a customized publication 600 constructed in accordance with the method 500 discussed above. The publication 600 comprises cover components 605, one or more insert sheets 610 (two being shown in FIG. 6), and customized components 615 (one being shown in FIG. 6). Associating two of the cover components 605 together may define an opening 630.

FIG. 6 also shows another aspect of the present disclosure wherein the customized publication may include a pocket. Some aspects may provide for the pocket to act as the front cover or the back cover of the customized publication 600. More particularly, various aspects may further include gluing or otherwise associating two aligned cover components together at least on a top side and a bottom side of the aligned cover components. As such, the two aligned and glued cover components may form a pocket having an opening on an unglued side. As shown in FIG. 6, the customized insert sheet 610 may be die-cut to be smaller than the cover components and may then be inserted into the pocket. The pocket may be bound in the publication and act as a front cover or a back cover of the publication. In some cases, the cover components may also be customized to a recipient.

Additionally, in some embodiments, the publication 600 may further include an extended portion 620 (shown in dotted lines in FIG. 6), wherein the extended portion 620 may be folded or otherwise used to cover an opening of the pocket or opening 630. That is, one of the two cover components 605 may be wider than the other cover component 605 (e.g., the extended portion 620). As such, the excess portion of the wider cover component 605 may be folded over the opening of the opening 630 or the pocket. For example, one cover component 605 may be 1½ inches wider than the other cover component 605. Aligning the two components on three edges (e.g., top, bottom, binding edge) results in an overhanging 1½ panel. Gluing the components together on the top and bottom edges (and attaching the cover to the rest of the magazine on the binding edge) creates a pocket with an opening on the non-glued, unbound edge. The overhanging panel may be folded over the opening of the pocket.

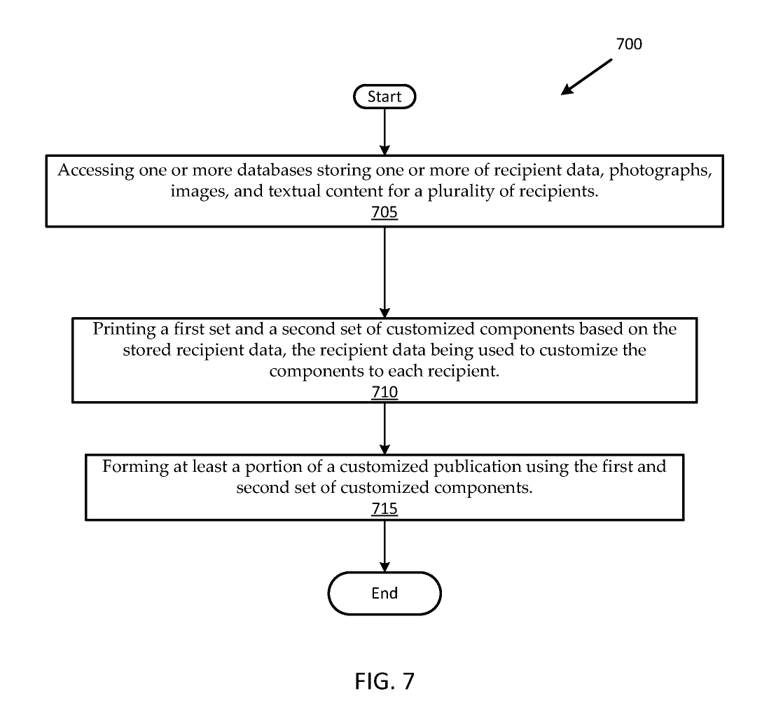

FIG. 7 shows a flow diagram of yet another exemplary method 700 for manufacturing a customized publication in accordance with the present disclosure. Generally, the method 700 may be utilized to produce a customized publication, such as is described herein. The method 700 may include a step 705 of accessing one or more databases storing one or more of recipient data, photographs, images, and textual content for a plurality of recipients. In some embodiments, at least one of the one or more databases may provided by a different provider. The method 700 may further include a step 710 of printing a first set and a second set of customized components based on the stored recipient data, the recipient data being used to customize the components to each recipient.

The method 700 may even further include a step 715 of forming at least a portion of a customized publication using the first and second set of customized components. The customized publication may be provided for binding to an uncustomized section. Further, the first set of customized components may be printed on a different paper stock than the second set of customized components.

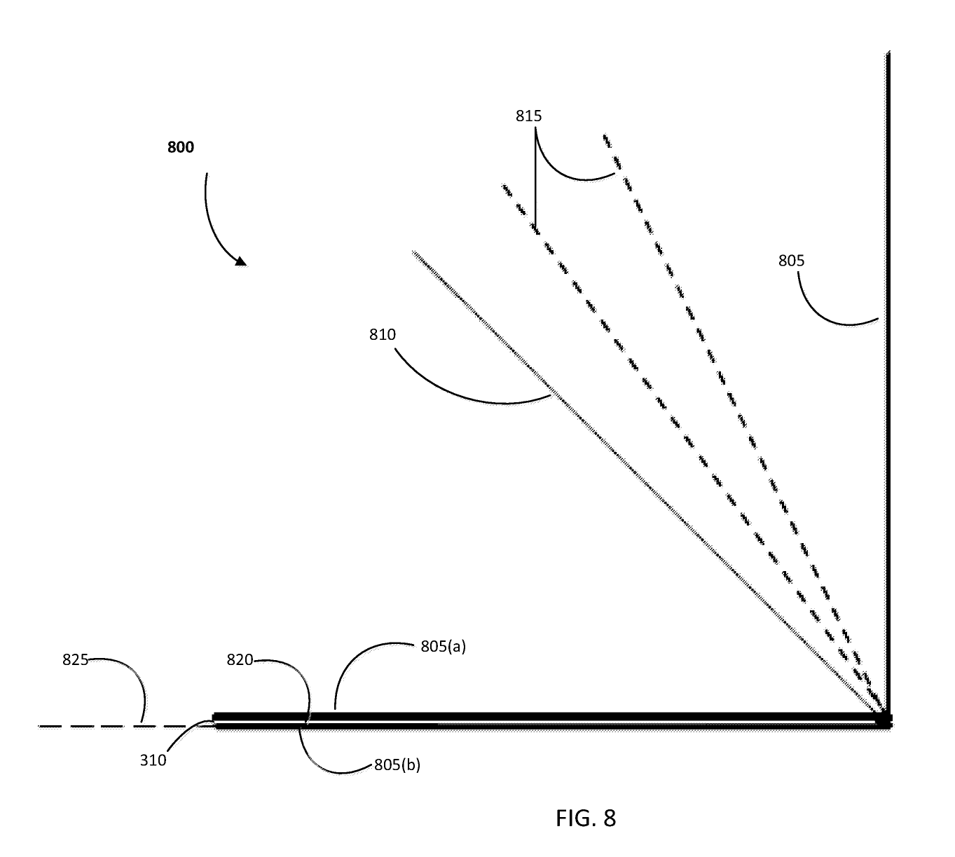

FIG. 8 is a side view of a customized publication 800 showing in greater detail the pocket feature discussed above. The publication 800 includes cover components 805, a customized portion 810, and a plurality of inserts 815. As shown in FIG. 8, two of the cover components 805 (identified as reference numerals 805(a) and 805(b)) are associated together. The associated cover components 805(a) and 805(b) define a pocket 820. An insert 825 (e.g., a customized insert) can then be inserted into the pocket 820. One of the two cover components may include a cut out (not shown) to enable easier access to the contents of the pocket. Opening 310 may be positioned at one or more locations, where for example the two cover components 805 are not coupled. In some embodiments, opening 310 may be along one or more edges of publication 800. In further embodiments, opening 310 may be a cut out or cut outs (not shown) in cover components 805 (e.g., cover component 805(b)) to enable access to pocket 820.

Turning now to more particular, but not limiting, features of the present disclosure. Various embodiments may provide for an exemplary method including printing a plurality of components for a set of publications. The plurality of components may include cover components and insert sheets customized to the recipient. The cover component may be, for example, a rectangular sheet of printed paper. Various aspects may provide for the cover components to be the same or different paper stock than the rest of the pages or insert sheets in the publication. Likewise, the insert sheets may be the same or different stock (e.g., gloss coating, matte coating, uncoated offset, lightweight, heavyweight, etc.) than the cover components.

Various embodiments may also provide for an exemplary method including printing a customized cover for the publication, printing customized inserts wherein the inserts are personalized for the recipient, matching and then gluing the customized cover and inserts together to form a customized publication.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

What is claimed is:

1. A method for manufacturing a customized publication, the method comprising:
printing a first set of customized components for each publication, the first set including a component customized to a recipient;
printing a second set of customized components for each publication, the second set including a component that is customized to the recipient; and
associating the component from the first set with the component from the second set to form a customized publication section for the recipient.

2. The method of claim 1, further comprising providing the customized publication section for associating with an uncustomized section.

3. The method of claim 1, further comprising accessing a database storing recipient data, wherein the recipient data is used to print the customized components from the first and second sets for the recipient.

4. The method of claim 1, further comprising accessing a database storing one or more of recipient data, photographs, images, and textual content, wherein the recipient data, photographs, images, and textual content are used to print the customized components from the first and second sets for the recipient.

5. The method of claim 1, further comprising accessing a plurality of databases storing recipient data used to print the customized components for the recipient, wherein at least two of the plurality of databases are provided by different providers.

6. The method of claim 1, wherein the first set of customized components are printed on a different paper stock than the second set of customized components.

7. The method of claim 6, wherein the different paper stocks differ from each other based upon one or more of weight, color, texture, thickness, finishing, composition, and dimensions.

8. The method of claim 1, wherein the components are associated using one or more of glue, staples, stitching, sewing, tape, metal, and resin.

9. A product manufactured using the method of claim 1, wherein the publication is a magazine, a booklet, a catalog, or a newsletter.

10. A method for manufacturing a customized publication, the method comprising:
printing a plurality of components for a set of publications, the plurality of components including cover components, one or more insert sheets, and customized components, the one or more insert sheets and customized components being customized to a recipient;
associating two of the cover components together, the two associated cover components defining an opening;
inserting one or more of the insert sheets into the opening; and
associating the two cover components with the customized components to form a customized publication.

11. The method of claim 10, wherein at least the cover components and customized components are associated using one or more of glue, staples, stitching, sewing, tape, metal, and resin.

12. The method of claim 10, wherein the cover components are customized to the recipient.

13. The method of claim 10, further comprising selecting cover components and customized insert sheets having different physical properties.

14. The method of claim 13, wherein the physical properties include one or more of a style, a weight, a color, a texture, a thickness, a finish, a pattern, a composition, and dimensions.

15. The method of claim 10, wherein associating the two cover components further defines a pocket, the pocket acts as a front cover or a back cover of the customized publication.

16. The method of claim 10, further comprising providing the customized publication section for associating with an uncustomized section.

17. The method of claim 10, further comprising accessing one or more databases storing recipient data for a plurality of recipients, wherein the recipient data is used to print the one or more insert sheets and the customized components for the recipient.

18. A product manufactured using the method of claim 10, wherein the publication is a magazine, a booklet, a catalog, or a newsletter.

19. A method of manufacturing a customized publication, the method comprising:
accessing one or more databases storing one or more of recipient data, photographs, images, and textual content for a plurality of recipients;
printing a first set and a second set of customized components based on the stored recipient data, the recipient data being used to customize the components to each recipient; and
forming at least a portion of a customized publication using the first and second set of customized components.

20. The method of claim 19, further comprising providing the customized publication for binding to an uncustomized section.

21. The method of claim 19, wherein the first set of customized components are printed on a different paper stock than the second set of customized components.
